(19) United States
(12) Patent Application Publication
(10) Pub. No.: US 2015/0066715 A1
(43) Pub. Date: Mar. 5, 2015

(54) Fuel excise tax calculation and filing system and method

(71) Applicant: Richard Wayne Carrier, San Antonio, TX (US)

(72) Inventor: Richard Wayne Carrier, San Antonio, TX (US)

(73) Assignee: Innovative Software Solutions, San Antonio, TX (US)

(21) Appl. No.: 13/999,367

(22) Filed: Feb. 19, 2014

Related U.S. Application Data
(60) Provisional application No. 61/872,435, filed on Aug. 30, 2013.

(51) Int. Cl. G06Q 40/00; G06Q 50/06

(52) U.S. Cl. CPC G06Q 40/123; G06Q 50/06
USPC 705/31

(57) ABSTRACT

In a fuel excise tax calculation and filing system, a method of generating a set of tax schedules based upon a set of user modified compliance rules without modifying the underlying software code. The system includes an interface process module operable to receive external transactional data and generate internal raw data. The system also includes a compliance matrix process operable to receive the internal raw data and a set of compliance rules maintained by the end user and generates compliant tax schedules for filing. The system also includes a graphical user interface for viewing and modifying the respective databases utilized in the system. The system also contains a form calculation process operable to generate compliant tax schedules. The disclosed method provides a more effective means of updating the fuel excise tax calculation and filing method and system by the end user, without a need to modify underlying software code.

### CROSS-REFERENCE TO RELATED APPLICATIONS

This application claims priority to U.S. Provisional Patent Application Ser. No. 61/872,435 (“Parent Provisional”), filed Aug. 30, 2013. The foregoing Parent Provisional is hereby incorporated by reference in its entirety as if fully set forth herein.

### FIELD OF THE INVENTION

This disclosure relates generally to system for calculating state and federal taxes on fuels and filing tax returns to the IRS and the state taxing authorities and more specifically to systems and methods that can be setup and modified by a end user to handle the various fuel products handled by the end user without having to pay a third party software provider to modify software code.

### BACKGROUND OF THE INVENTION

Many businesses involved in the movement of various fuel products are required to collect and report taxes at the point of sale. Fuel products include various gasoline products, diesel products, and natural gas products. Delivery mechanisms of fuel products include various pipelines, rail, tanks, trucks and dispensing products at the various stations. Various federal, state, and local fuel taxes may include fixed per gallon taxes as well as taxes as a percentage of the sales price. Fuel taxes may be imposed on terminal operators, on commercial transporters that travel through a state, even if the fuel is not purchased in that state, or on other modes of transferring fuels. Due to the number and variety of fuel products, the number of federal, state, and local taxes imposed, and the types and styles of transfers, software used to record, calculate, and file the tax reports needed to comply with the various agencies can be rather complex. End users of fuel tax calculation and filing software must often have software suppliers provide modifications to the software code when the end user decides to add a new product, modify a mode of disbursement, or fuel taxes are updated from the various taxing authorities. Modifying the software code is time consuming and costly. End users wishing to market new fuel products, alter modes of transporting those fuel products, or sell into new markets incur costly delays waiting on software updates. Thus, a need exists for a method and system that provides a fuel tax calculation and filing system that overcomes the above-noted deficiencies of prior art and can be setup and modified by a end user, to add products, categories of products and dates to all allow calculations of state and federal fuel taxes along with detecting errors and allowing the end user to correct those errors.

An object of the invention is to provide a fuel tax calculation and filing system and method that can be setup and modified by a end user to handle the various fuel products handled by the end user without having to have a software supplier modify the software code.

Another object of the invention is to provide a fuel tax calculation and filing system and method that has compliance matrix that allows the end user to make changes in the software, adding products and categories of products and dates to allow calculation of state and federal fuel taxes.

Another object of the invention is to provide a fuel tax calculation and filing system and method that is customizable by the end user to handle the tax calculation and filing for all fuels in all states.

Another object of the invention is to provide a fuel tax calculation and filing system and method that has an error checker that detects errors in data and classification and allows the end user to correct the errors.

### BRIEF SUMMARY OF THE INVENTION

In accordance with some embodiments, a fuel excise tax software system includes an interface process operable to receive a plurality of external data and to generate, in response to the plurality of external data, a plurality of raw data. The fuel excise tax software system also includes a compliance matrix process operable to receive the plurality of raw data and a plurality of compliance rules and to generate, in response to the plurality of raw data and the plurality of compliance rules, a plurality of tax schedules. The fuel excise tax software system also includes a user interface operable to enable a user to view the plurality of compliance rules, the plurality of raw data, or the plurality of tax schedules. The user interface also allows the user to add to the plurality of compliance rules and to modify the plurality of compliance rules and the plurality of tax schedules.

In accordance with another embodiment, a method of calculating and filing a fuel excise tax is provided. In a fuel excise tax software system that includes an interface process software module, a compliance matrix process software module, and a user interface software module, the method includes receiving, by the interface process software module, a plurality of external data and generating a plurality of raw data, in response to receiving the plurality of external data. The method further includes the step of generating, by the compliance matrix process module, a plurality of tax schedules in response to receiving the plurality of raw data and a plurality of compliance rules. The method further comprises the steps of viewing, by the user interface software module, the plurality of compliance rules, the plurality of raw data, and the plurality of tax schedules. The method further comprises the steps of adding, by the user interface software module, one of the plurality of compliance rules and modifying, the plurality of compliance rules and the plurality of tax schedules.

### BRIEF DESCRIPTION OF THE DRAWINGS

A better understanding of the present system and method can be obtained when the following detailed description of an embodiment is considered in conjunction with the following drawings in which:

FIG. 1 illustrates, in block diagram form, an exemplary computer system could be used to illustrate various aspects of a fuel excise tax calculation and filing system according to some embodiments;

FIG. 2 illustrates in flow diagram form, a fuel excise tax calculation and filing system according to some embodiments;

FIG. 3A is a screen display illustrating an exemplary view of the raw data database as viewed through a graphical user interface according to some embodiments;

FIG. 3B is a continuation of the screen display of FIG. 3A illustrating an exemplary view of the raw data database as viewed through a graphical user interface according to some embodiments;

FIG. 4A is a screen display illustrating an exemplary view of the compliance rules database as viewed through a graphical user interface according to some embodiments;

FIG. 4B is a continuation of the screen display of FIG. 4A illustrating an exemplary view of the compliance rules database as viewed through a graphical user interface according to some embodiments;

FIG. 4C is a continuation of the screen display of FIG. 4B illustrating an exemplary view of the compliance rules database as viewed through a graphical user interface according to some embodiments; and

FIG. 5 illustrates, in flow diagram form, a compliance matrix method for the fuel excise tax calculation and filing system, according to some embodiments;

FIG. 6A is a screen display illustrating use of the user interface to review errors detected in the databases according to some embodiments; and

FIG. 6B is a screen display illustrating use of the user interface to correct errors detected in the database according to some embodiments.

In the drawings, similar elements will be similarly numbered whenever possible. However, this practice is simply for convenience of reference and to avoid unnecessary proliferation of numbers, and is not intended to imply or suggest that our invention requires identity in either function or structure in the several embodiments.

### SPECIFICATION

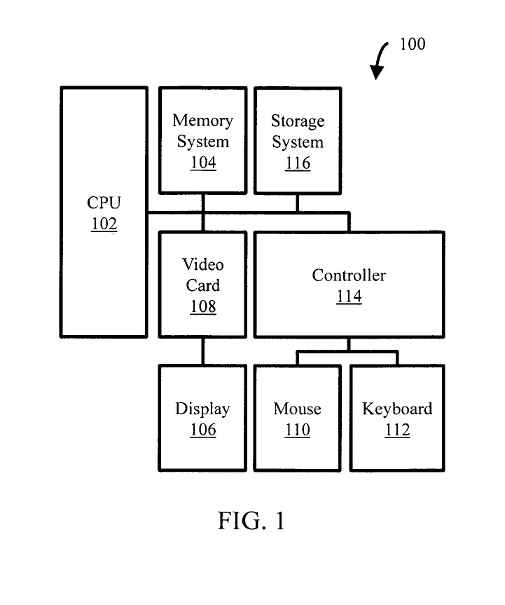

Detailed Description FIG. 1 illustrates, in block diagram form, an exemplary computer system 100 that could be used to illustrate various aspects of a fuel excise tax calculation and filing system according to some embodiments. The computing system 100 includes a central processing unit (CPU) 102 and a memory system 104. The CPU 102 is operably connected to the memory system 104 by a bus system such as one or more Peripheral Component Interconnect extended (PCIx) buses, industry standard architecture (ISA) buses, Accelerated Graphics Port (AGP) buses, and the similar buses utilized for these types of computer systems as known to one of ordinary skill in the art. The CPU 102 incorporates any one of several microprocessors such as Celeron™, Core i3™, Core i5™, etc. from Intel Corp. or other similar microprocessors as known to one of ordinary skill in the art. The memory system 104 may include a memory controller or the like and be implemented with one or more circuits such as DDR, DDR2, DDR3 although any memory configuration is contemplated.

The computing system 100 may include one or more output device such as a monitor or display 106 operably connected to the CPU 102 via an appropriate video card 108. One or more input devices may also be provided such as a mouse 110 and a keyboard 112, each operably connected via an appropriate controller 114 as known to those skilled in the art. A storage system 116 is operably coupled to the bus system and may include any one or more data storage devices, such as one or more disk drives including floppy and hard disk drives, solid state drives, flash drives, one or more CD-ROMs, DVDs, Blu Ray disks, one or more tape drives, or any other storage means, etc. The input and output devices enable a user to interact with the computing system 100 for purposes of utilizing the fuel excise tax calculation and filing system, as further described below.

A fuel excise tax calculation and filing software system according to the present invention may be stored in the storage system 116. This fuel excise tax application program is retrieved into the memory system 104 and executed by the CPU 102. As described more fully below, the application program retrieves local files, such as stored in the storage system 116. Although reference is made in the specification and claims to computer files, it is understood that the term files encompasses documents and any other digital object that contains machine or individual readable or searchable information. The computing system 100 is included to illustrate that a fuel tax calculation and filing system and method, according to the present invention, may be realized on a modern computing machine with a CPU, random access memory (RAM) and external storage, such as the storage system 116. The computer system 100 enables a user-friendly graphic user interface (GUI) implementation with display and input capabilities. There are no explicit restrictions on CPU architecture or display technology.

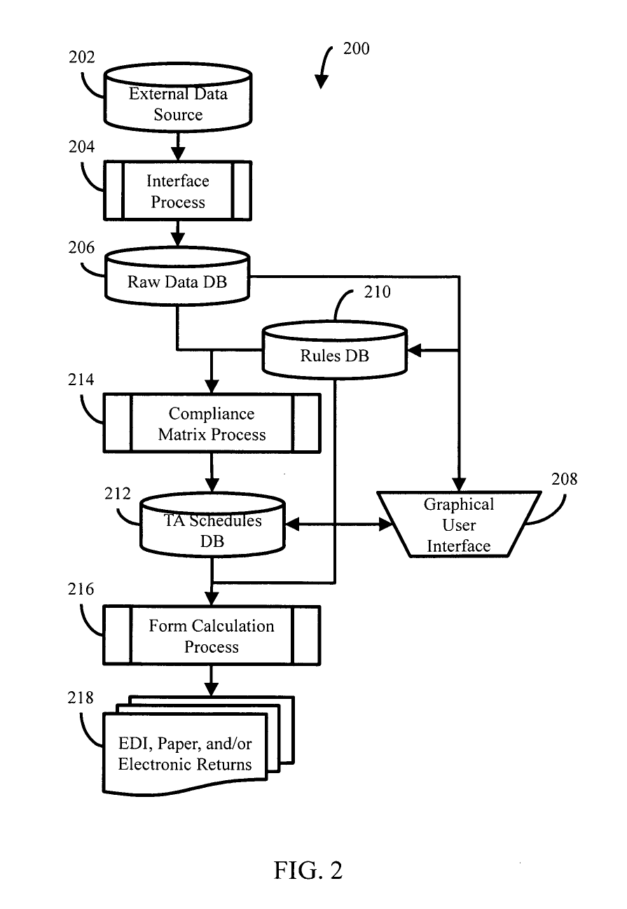

FIG. 2 illustrates in flow diagram form, a software fuel excise tax calculation and filing method and system 200 according to some embodiments. The fuel excise tax calculation and filing method and system 200 generally includes an external data source 202 and an interface process 204. The external data source 202 generally includes transactional data representing business's movements of oil and gas products and typically are an output from accounting and tracking software provided by companies such as SAP, Oracle and other software providers. The external data source 202 may be stored in the memory system 104 of FIG. 1 or stored on the storage system 116 of FIG. 1. The external data source 202 may also be read across a network (not shown) or by any other means understood by one of ordinary skill in the art. The interface process 204 generally includes an application programming interface (API) adapted to read the data from the external data source 202. The interface process 204 reads the data records from the external data source 202, generates corresponding raw data records and writes those raw data records to the raw data database 206. The raw data database 206 is generally a database analogous to those generated by SAP, Oracle and other providers. The raw data database 206 may be generally stored as a relational database and operable to respond to commands written in any language such as Structured Query Language (“SQL”) database programming language and other suitable database programming languages. The raw data database generally includes transactional records where each record represents a sales transaction, a transfer transaction, or other similar transactions understood by one of ordinary skill in this art. Each individual record generally includes multiple fields as further described below. The raw data database 206 may be stored in the memory system 104 of FIG. 1 or stored on the storage system 116 of FIG. 1 or accessible via other means understood by one of ordinary skill in the art.

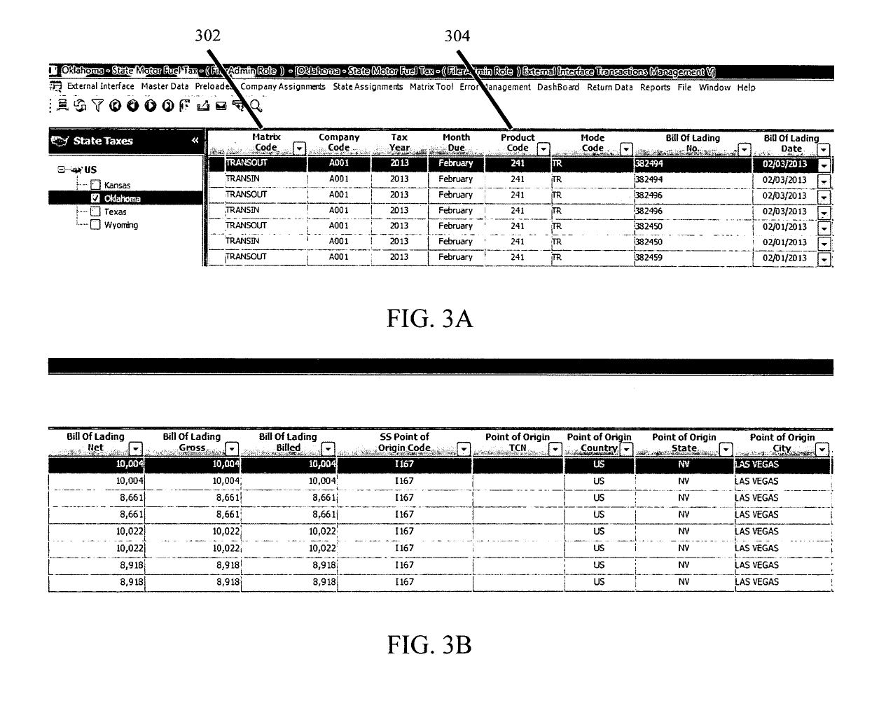

The raw data database 206 may be accessed by a user using the graphical user interface (GUI) 208. The GUI 208 is a software module that allows users to interact with the raw data database 206, the rules tables database 210, and the taxing authority schedules database 212. Referring to FIG. 3A and FIG. 3B, screen displays illustrate exemplary views of the raw data database as viewed through the GUI according to some embodiments. Each record received from the external data source 202 of FIG. 2 and written into the raw data database 206 of FIG. 2 contains multiple fields, as illustrated in FIG. 3A and FIG. 3B. One such exemplary field is the matrix code field 302, representing the type of transfer associated with the transactional data. Exemplary transfer types may include non-taxable exchanges between parties, taxable purchases from one party by another, and other similar transfer types understood by one of ordinary skill in this art. Another exemplary field is the product code 304, representing the type of product transferred. Exemplary types of products include motor fuel, gasoline, distillates, diesel, special fuels and other similar fuel types understood by one of ordinary skill in this art. Each of these various products have a unique and specific product code. Table 1 provides a non-limiting list of other exemplary fields available in the raw data database 206.

TABLE 1
Exemplary Fields of Raw Data Database

| Matrix Code | Company Code | Tax Year | Month Due |
|---|---|---|---|
| Product Code | Mode Code | Bill of Lading | Bill of Lading |
| | | No. | Date |
| Bill of Lading | Bill of Lading | Bill of Lading | SS Point of |
| Net | Gross | Billed | Origin Code |
| Point of Origin | Point of Origin | Point of Origin | Point of Origin |
| TCN | Country | State | City |
| Point of Origin | Point of Origin | SS Point of | Point of Desti- |
| ZIP Code | ZIP + 4 | Destination Code | nation TCN |
| Point of Desti- | Point of Desti- | Point of Desti- | Point of Desti- |
| nation Country | nation State | nation City | nation ZIP Code |
| Point of Desti- | | | |
| nation ZIP + 4 | | | |

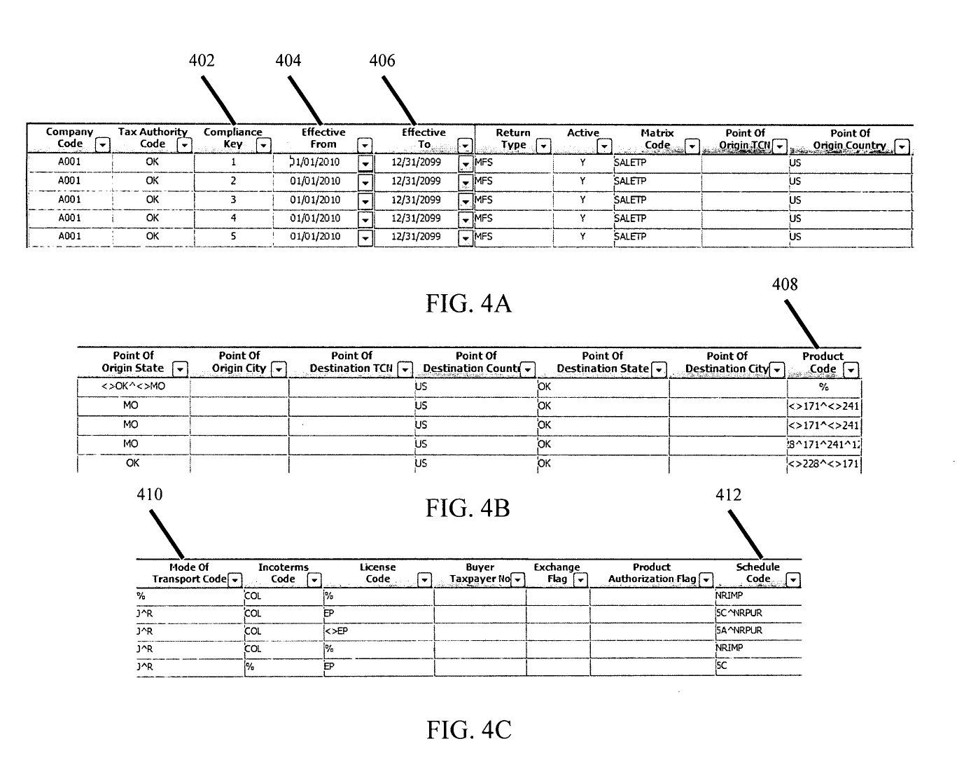

Referring back to FIG. 2, the compliance rules database 210 may be viewed, edited and modified by the user using the GUI 208. The compliance rules database may include both taxing authority rule sets and user created rule sets. Taxing authorities provide a set of certified rule sets for compliance checking which are loaded into the compliance rules database as data is normally loaded into a database as understood by one of ordinary skill in the art. Referring to FIG. 4A, FIG. 4B, and FIG. 4C, screen displays illustrate exemplary views of the compliance rules database as viewed through the GUI 208 according to some embodiments. Each line represents a compliance matrix rule for a party and includes compliance criterion provided by the taxing authority or created by the user. Each line includes multiple fields with each field providing the criteria for that particular field, indicated by the header. Other compliance criteria may be included in the compliance matrix rule by the party seeking to file their taxes using this application software for the fuel excise tax calculation and filing method and system 200. Additionally, criteria may be edited, augmented, or changed by the party based upon the specific need. Some fields in the rule are editable and some fields are fixed and may not be edited.

As an example, referring to FIG. 4A, the first compliance rule in the database has a non-editable field labeled “compliance key” 402 and is assigned the value of 1, hereinafter referred to as Rule No. 1. Reading across the line, Rule No. 1 has an “effective from” field 404 and is assigned the value of “Jan. 1, 2010”. Rule No. 1 also has an “effective to” field 406 and is assigned the value of “Dec. 31, 2099”. These dates are criteria against which transactions from the raw data database 206 will be assessed, as further described below. Referring to FIG. 4B, which is a continuation of the database view, Rule No. 1 has a “product code” field 408 that is assigned a value specified as the logical list of product codes. In this case, the “product code” of Rule No. 1 has been assigned a text string value of “< >171̂< >241”. The character “̂” represents a separator between values. The characters “< >” represent a NOT clause, logically matching all codes that are not the code following the character string. In this example, the string “< >171” would match all product codes that are NOT the numeric code “171” and NOT the numeric code “241”. Other characters used in defining this field may include the “%” character, representing a wildcard that allows any value for the column. As can be seen from this example, product codes 408 may be a single value, may be a list of values, or may be a list of negative values. Negative values are products that are not valid for the specific rule. Referring to FIG. 4C, other exemplary fields include the mode of transport code 410 and the tax schedule code 412. The tax schedule code 412 provides for a list of valid tax schedules for which the specific rule is applicable. The tax schedule code 412 may be a single schedule, or may be a list of schedules.

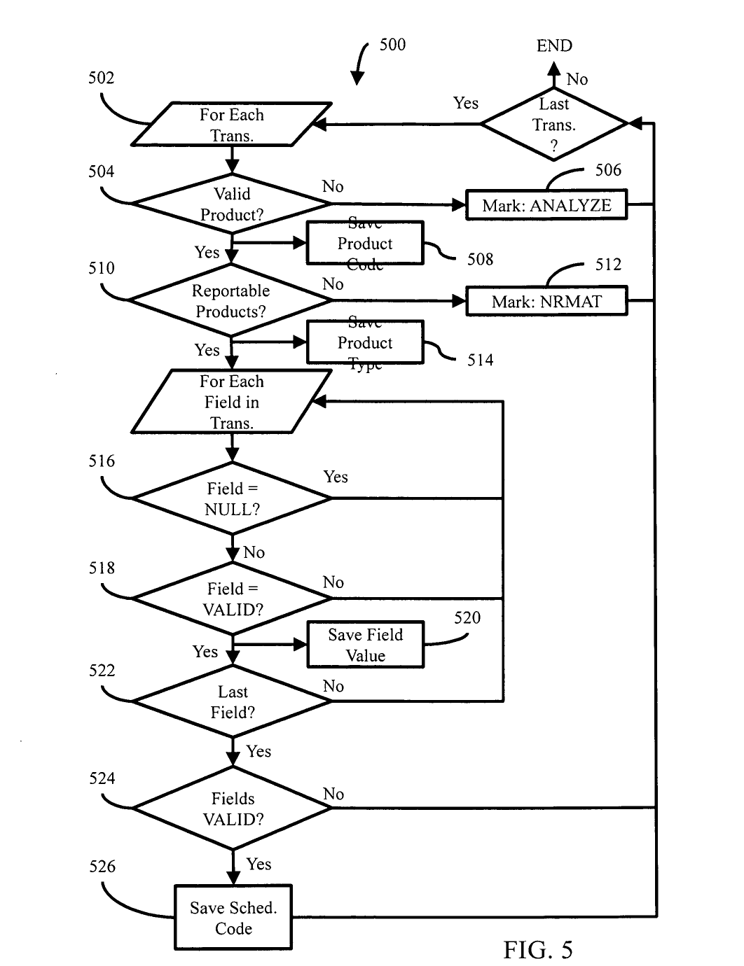

Referring back to FIG. 2, the compliance matrix process 214 receives input from the raw data database 206 and the compliance rules database 210 and after executing the compliance matrix method, outputs a taxing authority schedule record to the taxing authority schedules database 212. Referring to FIG. 5, an illustration is provided, in flow diagram form, of a compliance matrix process method 500 for the fuel excise tax calculation and filing system, according to some embodiments. As shown in FIG. 5, the method for compliance checking analyzes each of the transactional records in the raw data database 206 of FIG. 2 (see, 502). The initial step of the compliance checking process is confirming the validity of the product code 304 of FIG. 3A (see, 504). If the product code 304 in invalid, the transaction is marked for later analysis (see, 506), the transaction containing the invalid product code 304 is written to the taxing authority schedules database 212 of FIG. 2, the analysis for that transaction is terminated and the next transactional analysis is initiated. Valid product codes are recorded (see, 508) and are saved to the taxing authority schedules database 212 of FIG. 2 after the transaction has been fully checked for compliance and the full record has been created as described further below.

Compliance matrix method 500 next confirms that the product transaction being processed is a reportable product (see, 510). A reportable product transaction is one which does not necessarily require a tax to be paid, but may need to be recorded on a separate schedule. Product code 304 of FIG. 3A provides the basis for this determination. Non-reportable product transactions are marked as non-reportable (see, 512), the transaction containing the non-reportable product code 304 is written to the taxing authority schedules database 212 of FIG. 2, the analysis for that transaction is terminated and the next transactional analysis is initiated. Reportable product codes are recorded (see, 514) and are saved to the taxing authority schedules database 212 after the transaction has been fully checked for compliance and the full record has been created as described further below.

Upon determining that a valid, reportable product is being analyzed, the compliance matrix method 500 proceeds to analyze each field in the transactional record. For each field contained in the transactional record, the compliance matrix method 500 first validates the field is not a NULL value (see, 516). If the field under analysis is found equal to NULL, the process moves to the next field without taking further action. If the field is not found equal to NULL, the compliance matrix method checks that the field value is valid (see, 518). Validity of a specific field could be merely that it exists, or that is complies with specific criteria. Table 2 provides the expected values for each field against which validity of the field is checked.

TABLE 2
Compliance Matrix Field Value

| | Field | Value |
|---|---|---|
| 1. | Return Type | True |
| 2. | Effective From Date | Valid based |
| | | on date |
| 3. | Effective To Date | Valid based |
| | | on date |
| 4. | Active Flag | True |
| 5. | Matrix Code Value | True |
| 6. | Point of Origin TCN | True |
| | Value | |
| 7. | Point of Origin Country | True |
| | Value | |
| 8. | Point of Origin State | True |
| | Value | |
| 9. | Point of Origin City | True |
| | Value | |
| 10. | Point of Destination | True |
| | TCN Value | |
| 11. | Point of Destination | True |
| | Country Value | |
| 12 | Point of Destination | True |
| | State Value | |
| 13. | Point of Destination | True |
| | City Value | |
| 14. | Product Code Value | True |
| 15. | Mode of Transport Code | True |
| 16. | IncoTerms Value | True |
| 17. | License Code Value | True |
| 18. | Buyer Taxpayer No. Value | True |
| 19. | Destination IRS Terminal | True |
| | Flag Value | |
| 20. | Source System Point of | True |
| | Destination Value | |
| 21 | Source System Point of | True |
| | Origin Code Value | |
| 22. | Exchange Flag Value | True |
| 23. | Product Authorization Flag | True |
| | Value | |
| 24. | Gallons From Value | True |
| 25. | Gallons To Value | True |
| 26. | User Defined Field 1-10 | True |
| | Value | |

Valid field values are recorded (see, 520) and are saved to the taxing authority schedules database 212 of FIG. 2 after the transaction has been fully checked for compliance and the full record has been created. Compliance matrix method 500 repeats this set validation loop until the last field is detected (see, 522). Upon reaching the last field, compliance matrix method 500 checks that the expected fields are valid (see, 524). If the any fields are determined to be invalid, the analysis for that transaction is terminated and the next transactional analysis is initiated. If all fields are determined to be valid, the schedule code 412 of FIG. 4C is recorded and the transactional record is saved to the taxing authority schedules database 212 of FIG. 2 (see, 526).

Upon completing the compliance analysis for each transaction, the taxing authority schedules database 212 contains a completed set of transactions identified with valid data and identified with specific schedules. Referring to FIG. 2, the GUI 208 may be used by the user to review, modify, and/or correct the data within the taxing authority schedules database 212. If errors are found, the user may review, modify, and/or correct the rules contained within the compliance rules database 210. Where errors or warnings are found, the specific rule is traced via the compliance key 402 of FIG. 4A. Modifications to compliance rules database 210 are saved and the process is repeated. Once the data is deemed sufficient, the form calculation process 216 provides a means for generating EDI, paper, or electronic returns 218.

Referring to FIG. 2, form calculation process 216 receives input from the taxing authority schedules database 212 as well as the compliance rules database 210 and based upon the value the schedule code 412 of FIG. 4C generates a set of tax schedules in a variety of formats, including EDI, paper, or electronic returns. This processes of generating EDI formatted returns, PDF formatted returns and other similar formats are well known to those of ordinary skill in the art.

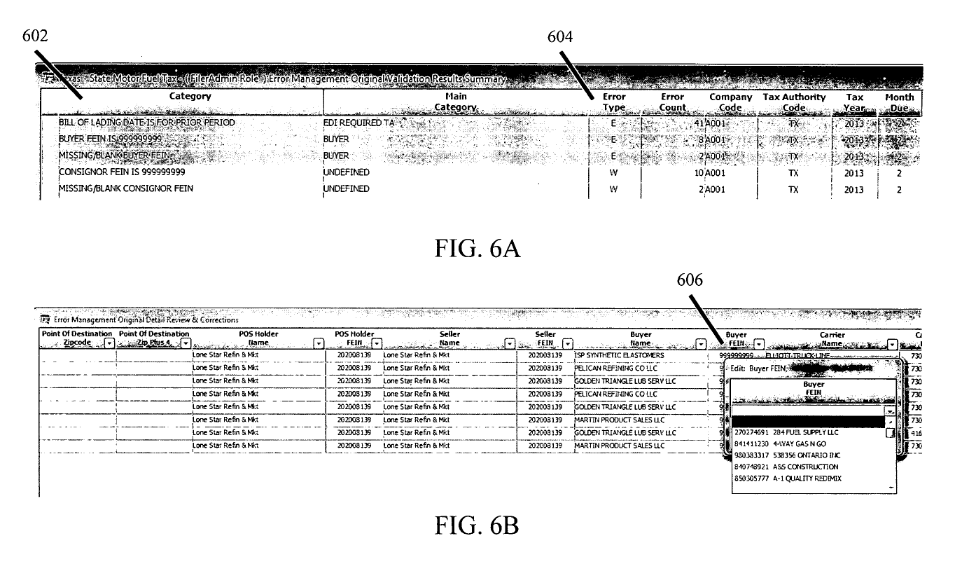

As an example, FIG. 6A and FIG. 6B are screen displays illustrating use of the user interface 208 of FIG. 2 to review and correct errors and warnings detected in the compliance rules database 210 of FIG. 2 and in taxing authority schedules database 212 of FIG. 2 according to some embodiments. In this example, errors and warnings have been detected and the user may view those errors using the user interface 208 of FIG. 2 as shown by FIG. 6A and FIG. 6B. “Category” 602 lists several types of errors and warnings detected, as indicated by “Error Type” 604. As one specific example, on line 2 of the exemplary screen display, the “Category” 602 has been assigned the value “buyer FEIN”. Reading across line 2, “Error Type” 604 has been assigned the value “E” indicating the FEIN number in the record is erroneous and should be corrected. Upon review, the user may open a different screen, illustrated in FIG. 6B, and apply corrective measures, modifying the data directly in the database for subsequent analysis. Here, the field “Buyer Type” 606 is illustrated being assigned a different value. Similar screens are available via the user interface 208 of FIG. 2 for viewing, adding, and/or modifying the various database discussed above.

Updates to the fuel excise tax calculation and filing method and system 200 are affected by the end user, without a need to modify underlying software code. Thus it is apparent that we have provided a method and system that provides a more effective means of effecting updates to the fuel excise tax calculation and filing method and system 200 without the need and expense of modifying the underlying code. Those skilled in the art will recognize that modifications and variations can be made without departing from the spirit of our invention. Therefore, we intend that our invention encompass all such variations and modifications as fall within the scope of the appended claims.

The invention claimed is:

1. In a fuel excise tax software system comprising:
an interface process operable to:
receive a plurality of external data; and
generate, in response to said plurality of external data, a plurality of raw data;
a compliance matrix process operable to:
receive said plurality of raw data and a plurality of compliance rules; and
generate, in response to said plurality of raw data and said plurality of compliance rules, a plurality of tax schedules; and
a user interface operable to:
enable a user to:
view a selected one of said plurality of compliance rules, said plurality of raw data, and said plurality of tax schedules;
add one of said plurality of compliance rules; and
modify a selected one of said plurality of compliance rules and said plurality of tax schedules.

2. The software system of claim 1 wherein said plurality of compliance rules comprises a taxing authority rule set and a user created rule set.

3. The software system of claim 2 wherein said user interface is further characterized as operable to enable said user to detect errors contained within a selected one of said plurality of said compliance rules and said plurality of tax schedules.

4. The software system of claim 3 wherein said user interface is further characterized as operable to enable said user to apply corrective measures to a selected one of said plurality of said compliance rules and said plurality of tax schedules.

5. The software system of claim 4 wherein said fuel excise tax software system is further characterized as comprising a form calculation process operable to:
receive said plurality of tax schedules and said plurality of compliance rules; and
generate, in response to said plurality of tax schedules and said plurality of compliance rules, a plurality of tax returns.

6. The system of claim 1 wherein the compliance matrix process operable to generate, in response to said plurality of raw data and said plurality of compliance rules, a plurality of tax schedules, said compliance matrix process is further characterized as comprising the following steps:
validating a product code of one of said plurality of raw data is a valid code;
validating said product code is a reportable product code;
validating a plurality of field values in said raw data;
validating a selected one of a plurality of field values is a valid tax schedule code; and
saving said product code, said reportable product code, plurality of field values, and said tax schedule code to said plurality of tax schedules;

7. In a fuel excise tax software system comprising an interface process software module, a compliance matrix process software module, and a user interface software module, a method of calculating and filing a fuel excise tax comprising the steps of:
receiving, by said interface process software module, a plurality of external data;
generating, by said interface process software module, a plurality of raw data, in response to receiving said plurality of external data;
generating, by said compliance matrix process module, a plurality of tax schedules in response to receiving said plurality of raw data and a plurality of compliance rules;
viewing, by said user interface software module, a selected on of said plurality of compliance rules, said plurality of raw data, and said plurality of tax schedules;
adding, by said user interface software module, one of said plurality of compliance rules; and
modifying, by said user interface software module, a selected one of said plurality of compliance rules and said plurality of tax schedules.

8. The method of claim 7 wherein said plurality of compliance rules comprises a taxing authority rule set and a user created rule set.

9. The method of claim 8 wherein said modifying, by said user interface software module, a selected one of said plurality of compliance rules and said plurality of tax schedules is further characterized as detecting errors contained within a selected one of said plurality of said compliance rules and said plurality of tax schedules.

10. The method of claim 9 wherein said modifying, by said user interface software module, a selected one of said plurality of compliance rules and said plurality of tax schedules is further characterized as applying corrective measures to a selected one of said plurality of said compliance rules and said plurality of tax schedules.

11. The method claim 10 wherein said fuel tax software system is further characterized as comprising a form calculation software module, said method of calculating and filing a fuel excise tax further comprising the steps of:
receiving, by said form calculation software module, said plurality of tax schedules and said plurality of compliance rules; and
generating, by said form calculation software module, in response to said plurality of tax schedules and said plurality of compliance rules, a plurality of tax returns.

12. The method of claim 7 wherein said generating, by said compliance matrix process module, a plurality of tax schedules in response to receiving said plurality of raw data and a plurality of compliance rules is further characterized as comprising the following steps:
validating a product code of one of said plurality of raw data is a valid code;
validating said product code is a reportable product code;
validating a plurality of field values in said raw data;
validating a selected one of a plurality of field values is a valid tax schedule code; and
saving said product code, said reportable product code, plurality of field values, and said tax schedule code to said plurality of tax schedules;
